(19) United States
(12) Patent Application Publication
(10) Pub. No.: US 2026/0340697 A1
(43) Pub. Date: Oct. 29, 2026

(54) WIRE PRODUCT CONVERSION SYSTEM AND METHOD

(71) Applicant: Southwire Company, LLC, Carrollton, GA (US)

(72) Inventors: Edwin Wladimir Marquez Tolentino, Carrollton, GA (US); Yushin Hawig, Carrollton, GA (US)

(21) Appl. No.: 19/661,373

(22) Filed: Apr. 28, 2026

Related U.S. Application Data
(60) Provisional application No. 63/796,811, filed on Apr. 29, 2025.

(51) Int. Cl. G06Q 30/0601

(52) U.S. Cl. CPC G06Q 30/06212; G06Q 30/06434

(57) ABSTRACT

A wire product conversion system and method are provided. In example aspects, a user may input a conversion type and product characteristics at a wire product conversion user interface, and the user interface may be updated to present converted wire products. For example, the converted wire products may be wire products that have a similar ampacity or other attribute to a baseline wire product identified by the conversion type and the product characteristics, but a different conductor material. In further example aspects, installation conditions may be input at the wire product conversion user interface, and the installation conditions may be used to filter the converted wire products.

### CROSS-REFERENCE TO RELATED APPLICATIONS

This application claims the benefit of and priority to U.S. Provisional Patent Application No. 63/796,811, filed on Apr. 29, 2025, the disclosure of which is hereby incorporated by reference in its entirety.

### BACKGROUND

When selecting a wire product for a wiring project, individuals must choose between a variety of potential wire products. In some cases, there may be multiple wire products that are compatible for the wiring project, so the user must choose between the compatible wire products. However, the user may only know one of the compatible wire products and may not be aware of what other products are available. Further, the user may not know how the compatible wire products differ from one another and therefore may not know which wire product is best for their needs. To determine which wire product is best for the user's needs, the user may need to consider characteristics of the wire products, which may be designed and governed by ASTM standards or other similar standards.

Additionally, accurately converting a wire product from one conductor material to another requires cross-referencing multiple technical data sources, including NEC ampacity tables, manufacturer-specified physical dimensions, and installation constraint databases. Manual conversion is error-prone, time-consuming, and cannot dynamically apply NEC correction factors—such as ambient temperature derating and conductor bundling adjustments—to validate code compliance under real-world installation conditions. Additionally, conventional computing systems are not configured to dynamically determine code-compliant electrical conductor substitutions under variable installation conditions. In particular, existing systems lack the ability to concurrently apply multiple interacting electrical constraints—including ampacity tables, temperature derating factors, conductor bundling rules, and physical installation limitations—within a unified computational framework. As a result, prior systems either (i) rely on static lookup tables that fail to account for real-world conditions, or (ii) require manual multi-step calculations that are not computationally integrated and are prone to inconsistency and error.

### SUMMARY

In general terms, this disclosure is directed to a wire product conversion system and method. In example aspects, a user may input a conversion type and product characteristics at a wire product conversion user interface, and the user interface may be updated to present converted wire products. For example, the converted wire products may be wire products that have a similar ampacity (or other attribute) to a baseline wire product identified by the conversion type and the product characteristics, but a different conductor material. In further example aspects, installation conditions may be input at the wire product conversion user interface, and the installation conditions may be used to filter the converted wire products.

In a first aspect, a method for converting wire products is provided. A wire product conversion user interface is presented at a computing device. The wire product conversion user interface includes a conversion type control and a product characteristics control. A conversion type input including at least a conductor material of a baseline wire product is received via the conversion type control of the wire product conversion user interface at the computing device. A product characteristic input including one or more characteristics of the baseline wire product is received via the product characteristics control of the wire product conversion user interface at the computing device. Based on the conversion type input and the product characteristic input, the baseline wire product is determined. An ampacity of the baseline wire product is determined. One or more converted wire products are selected based on the ampacity of the baseline wire product. The one or more converted wire products have a different conductor material than the baseline wire product. The one or more converted wire products are presented via the wire product conversion user interface at the computing device.

In a second aspect, a wire product conversion system is provided. The wire product conversion system comprises one or more processors and one or more computer-readable storage devices storing data instructions. Execution of the data instructions by the one or more processors causes the wire product conversion system to generate a wire product conversion user interface, provide the wire product conversion user interface to a computing device, receive a request for converted wire products including a conversion type and one or more product characteristics via the wire product conversion user interface at the computing device, determine a baseline wire product based on the conversion type and the one or more product characteristics, determine an attribute of the baseline wire product, select one or more converted wire products from a plurality of wire products based on the attribute of the baseline wire product, automatically generate an updated wire product conversion user interface including the one or more converted wire products in response to selecting the one or more converted wire products, and provide the updated wire product conversion user interface to the computing device. The wire product conversion user interface includes a conversion type control and a product characteristics control. The one or more converted wire products have a different conductor material than the baseline wire product.

In a third aspect, a system for converting wire products is provided. The system comprises one or more processors and one or more computer-readable storage devices storing data instructions. Execution of the data instructions by the one or more processors causes the system to present a wire product conversion user interface including a conversion type control and a product characteristics control, receive a conversion type input including at least a conductor material of a baseline wire product via the conversion type control of the wire product conversion user interface, receive a product characteristic input including one or more characteristics of the baseline wire product via the product characteristics control of the wire product conversion user interface, transmit the conversion type input and the product characteristic input to a wire product conversion server, receive one or more converted wire products from the wire product conversion server, and present the one or more converted wire products via the wire product conversion user interface. The conversion type input and the product characteristic input are usable by the wire product conversion server to determine the baseline wire product. The one or more converted wire products are selected by the wire product conversion server based, at least in part, on an ampacity of the baseline wire product, the one or more converted wire products having a different conductor material than the baseline wire product.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an environment in which aspects of the present disclosure may be implemented.

FIG. 2 illustrates an example embodiment of a wire product conversion system.

FIG. 3 illustrates another example of the wire product conversion system illustrated in FIG. 2.

FIG. 4 illustrates examples of product specifications.

FIG. 5 illustrates examples of product constraints.

FIG. 6 illustrates an example wire product conversion user interface.

FIG. 7 illustrates an example of inputting a conversion type at a conversion type control of a wire product conversion user interface.

FIG. 8 illustrates an example of inputting a product characteristic at a product characteristics control of a wire product conversion user interface.

FIG. 9 illustrates an example of converted wire products presented at a wire product conversion user interface.

FIG. 10 illustrates another example of converted wire products presented at a wire product conversion user interface.

FIG. 11 illustrates an example of inputting an installation condition at an installation conditions control of a wire product conversion user interface.

FIG. 12 illustrates an example of a warning associated with a converted wire product presented at a wire product conversion user interface.

FIG. 13 illustrates another example of inputting an installation condition at an installation conditions control of a wire product conversion user interface.

FIG. 14 illustrates another example of a warning associated with a converted wire product presented at a wire product conversion user interface.

FIG. 15 illustrates a flowchart of an example method for converting wire products.

FIG. 16 illustrates a flowchart of another example method for converting wire products.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As used herein, the term “including” should be read to mean “including, without limitation,” “including but not limited to,” or the like. Additionally, as used herein, the term “wire products” should be read to include wire products, cable products, conductor products, and other similar electrical products.

As briefly described above, embodiments of the present disclosure are directed to a wire product conversion system and method. In example aspects, a user may input a conversion type and product characteristics at a wire product conversion user interface, and the user interface may be updated to present one or more converted wire products. For example, the converted wire products may be wire products that have a similar ampacity (or other attribute) to a baseline wire product identified by the conversion type and the product characteristics, but a different conductor material. Product information about each of the baseline wire product and the converted wire products may be presented in the wire product conversion user interface, allowing a user to quickly determine differences between the wire products and determine which wire product best suits their needs. Other associated information may also be presented on the wire product conversion user interface to assist the user in determining which wire product is best for their needs. For example, information about pricing of component parts of the wire products, such as the conductors or the conductor materials, may be presented, allowing users to see trends in pricing.

In further example aspects, installation conditions may be input at the wire product conversion user interface, and the installation conditions may be used to filter the converted wire products. For example, a wire product may be incompatible with an installation condition or otherwise not suitable based on the installation condition. Accordingly, the wire product may not be presented with the converted wire products. In another example, the wire product may still be presented, but a warning may be presented on the user interface to warn the user that the wire product may not be compatible with the designated installation conditions. By filtering the converted wire products, the user may avoid wire products that, while similar to the baseline wire product, are not suited to their needs.

While examples described herein may describe building wire products, the scope of the present disclosure is not limited thereto. In other examples, any type of wire product may be converted to determine similar wire products, including utility wire products (e.g., overhead wire products and underground wire products), industrial wire products, and automotive wire products.

The wire product conversion system provides a technical improvement over manual wire product selection methods. Specifically, the system automates the application of NEC ampacity tables, correction factors, and installation constraint rules through an attribute calculator and wire product filter operating on a structured wire product database. This automation enables real-time, code-compliant conversion results that account for numerous factors, including ambient temperature, conductor bundling, conduit fill, and material-specific restrictions—operations that are not practically performable by a human operator without error and significant time delay. Specifically, the system integrates electrical performance calculations (voltage drop, weight percentage, DC resistance, ampacity derating), physical dimension validation, installation restriction checking, and real-time commodity pricing retrieval in a single automated operation across multiple databases and calculation modules. This integration cannot practically be performed manually, as it requires simultaneous cross-referencing of product specifications, product constraints, and real-time market data while applying multi-variable electrical calculations.

The system additionally provides improvements to the functioning of computer systems by implementing a structured attribute calculation and constraint evaluation pipeline that dynamically integrates multiple heterogeneous technical data sources. Unlike conventional lookup-based systems, the systems described herein enable calculation of real-time, installation-aware, code-compliant conductor substitutions, which cannot be achieved through static tables or isolated calculations. For example, as described herein, the wire conversion system may compute a corrected baseline electrical attribute from stored product specifications and applicable code-derived correction factors, identify candidate substitutes satisfying the corrected attribute, and evaluate candidate substitutes against stored physical and use-case constraints to automatically suppress incompatible substitutes or generate compatibility warnings. This ordered computational pipeline reduces redundant recalculations, avoids inconsistent multi-source manual analysis, and improves machine processing of conductor-substitution requests under variable installation conditions. Accordingly, the wire conversion system improves both computational accuracy and operational efficiency in electrical system design by reducing inconsistent results and eliminating redundant recalculation steps.

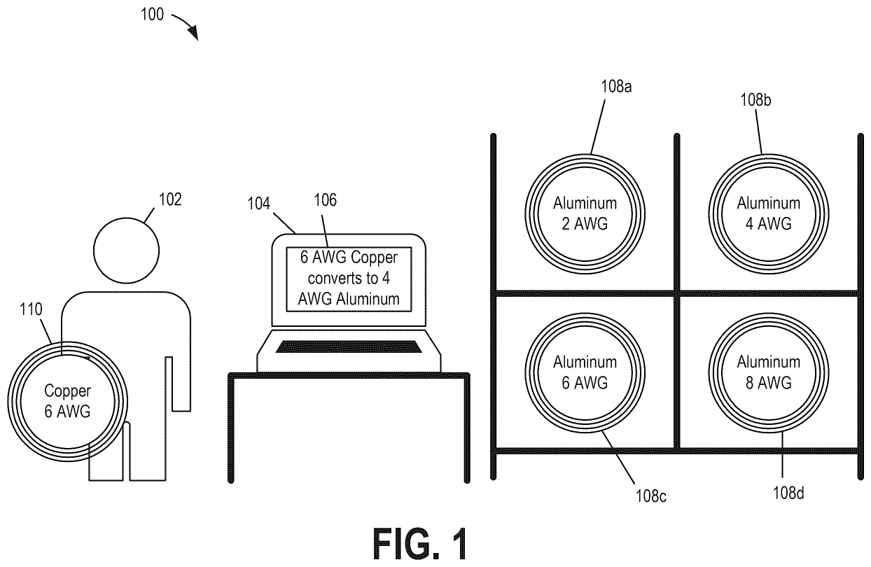

Turning now to FIG. 1, an example environment 100 in which aspects of the present disclosure may be implemented is shown. In the illustrated example, the environment 100 includes a user 102 shopping for wire products 108. For example, the user 102 may be shopping at a hardware store. In alternative examples, the environment 100 may be other locations, such as other stores or the user's 102 home. In the illustrated example, multiple wire products 108 are for sale in the environment 100.

The wire products 108 may be identified based on their size and conductor material. In further examples, other information may be used to identify the wire products, including wire type. In the illustrated example, the wire products 108 may be aluminum conductor wire products of different sizes. While the illustrated example shows aluminum as the conductor of the wire products 108, in further examples other conductor materials may be used in the wire products, including copper and steel.

In examples, wire sizes are expressed in wire gauges (AWG). A wire gauge may describe a diameter of the wire product. In the illustrated example, the wire products 108 range in size from 2 AWG to 8 AWG. In further examples, the wire products 108 may have different sizes. Further, in some examples, other units may be used to describe a wire size of the wire products 108. For example, the size of the wire products 108 may be described in circular mils (cmils), which describe an area of a cross-section of a wire product 108. In other examples, other units may be used to describe an area, diameter, or other size of the wire products 108.

In the illustrated example, the user 102 is shopping for a wire product for a wiring project. For example, the user 102 may be shopping for electrical wire for installing an outlet in a residential setting (e.g., the user's home). In an example, the user may be aware of a baseline wire product 110 that is compatible for the user's 102 wiring project. In the illustrated example, the baseline wire product 110 is a 6 AWG, copper conductor wire product. In an example, the user 102 may determine that the baseline wire product 110 is compatible for the wiring project using a wire product selection system as described in U.S. Provisional Patent Application No. 63/674,669, filed on Jul. 23, 2024, and entitled “Compatible Wire Product Selection System and Method,” the disclosure of which is hereby incorporated in its entirety.

The user 102, however, may want to determine what other wire products may be compatible for their wiring project. For example, the user 102 may wish to determine which, if any, aluminum conductor wire product is compatible with their wiring project. However, when converting the baseline wire product 110 to a converted wire product with a different conductor material, other characteristics of the wire product, such as the size, may need to be converted as well.

In the illustrated example, the user 102 may interact with a computing device 104 presenting a wire product conversion user interface 106. In example embodiments, as described further herein, the user 102 may interact with the wire product conversion user interface 106 to find one or more converted wire products—for example, wire products that perform similarly to the baseline wire product 110 but have a different conductor material. In embodiments, the user 102 may input a conversion type and product characteristics at the wire product conversion user interface 106.

The conversion type and product characteristics may be used to determine the converted wire products. For example, in the illustrated example, the baseline wire product 110 may be a 6 AWG, copper conductor wire product. Accordingly, in this example, the conversion type may indicate that the user 102 wants to convert a copper conductor wire product to an aluminum conductor wire product, and the product characteristics may indicate that the baseline wire product 110 has a size of 6 AWG. In an embodiment, to determine the converted wire products, an ampacity of the baseline wire product 110 is determined. In this example, the ampacity of a 6 AWG, copper conductor wire product may be determined to be 65 amps at 75 °C. Accordingly, the converted wire products may include wire products with an aluminum conductor and an ampacity of 65 amps at 75 °C. In this example, the converted wire product may be a 4 AWG, aluminum conductor wire product—i.e., the wire product 108b. In other examples, other attributes of the baseline wire product may be used to determine the converted wire products, including a weight of the baseline wire product or a rated breaking strength of the baseline wire product.

In some cases, there may not be a wire product with an ampacity that is exactly equivalent to the ampacity of the baseline wire product. In these cases, the converted wire products may include the wire products with the closest ampacities to the baseline wire product 110. In some examples, the converted wire products may include the wire products that have the closest ampacities to the baseline wire product 110 without the ampacities being lower than the ampacity of the baseline wire product 110.

In further cases, there may not be any wire products with a similar ampacity to the baseline wire product. For example, when converting from copper to aluminum, a size of the wire product increases to maintain a similar ampacity of the wire product. However, because wire products are manufactured in set sizes, there may not be an aluminum wire product that is manufactured at the size necessary to have an ampacity similar to a baseline wire product that has a copper conductor. Similarly, there may not be a copper wire product that is manufactured at a small size necessary to have a similar ampacity to a baseline aluminum wire product. In these cases, the wire conversion user interface 106 may present an indication that there are not converted wire products available.

After the converted wire products are determined, the wire product conversion user interface 106 may be automatically updated to present the converted wire products. In the illustrated example, as described above, the wire product conversion user interface 106 may identify the 4 AWG, aluminum conductor wire product as the converted wire product. In some examples, the wire product conversion user interface 106 may additionally present information about the baseline wire product 110 and the converted wire products. Accordingly, the user 102 can compare the baseline wire product 110 to the wire product 108b and determine which wire product better suits their needs.

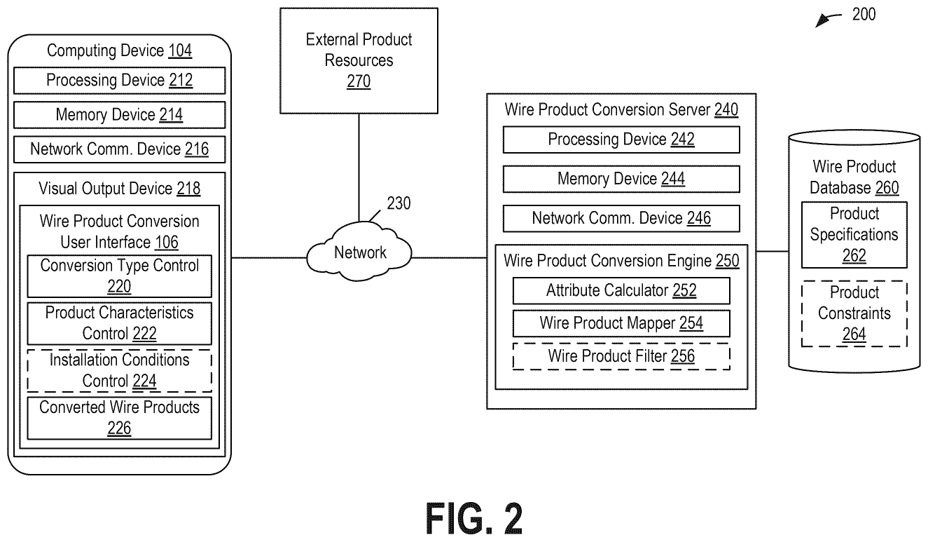

FIG. 2 illustrates an example embodiment of a system 200 for converting wire products. In the illustrated example, the system 200 includes a computing device 104 connected to a wire product conversion server 240. A network 230 may be used for communication between the computing device 104 and the wire product conversion server 240.

While the illustrated example shows a single computing device 104 connected to the wire product conversion server 240, in alternative examples, multiple computing devices 104 may connect to the wire product conversion server 240. Similarly, while the illustrated example shows a single wire product conversion server 240, in alternative embodiments, the system 200 may include multiple wire product conversion servers 240. In embodiments, functions of the wire product conversion server 240 as described herein may be split between multiple servers.

As described herein, the computing device 104 is used to present converted wire products 226 to a user (e.g., user 102 described above in connection with FIG. 1). In embodiments, the computing device 104 includes a processing device 212, a memory device 214, a network communication device 216, and a visual output device 218. In the illustrated embodiment, the visual output device 218 presents a wire product conversion user interface 106 including a conversion type control 220, a product characteristics control 222, and converted wire products 226. In some embodiments, the wire product conversion user interface 106 further includes an installation conditions control 224. Other embodiments of the computing device 104 may include additional, fewer, or different components. Examples of computing devices include a mobile device (e.g., a smartphone) and a computer (e.g., desktop, laptop, tablet, etc.).

In some embodiments, the processing device 212 comprises one or more processing devices, such as central processing units (CPU). In other embodiments, the processing device 212 additionally or alternatively includes one or more digital signal processors, field-programmable gate arrays, or other electronic circuits. In some embodiments, the processing device 212 includes at least one processing device that can execute program instructions to cause the at least one processing device to perform one or more functions, methods, or steps as described herein.

The memory device 214 operates to store data and program instructions. In an example, the memory device 214 stores program instructions for a browser that is used to view the wire product conversion user interface 106. In another example, the memory device 214 may store instructions for a wire conversion application that may be executed on the computing device 104.

The memory device 214 includes at least one memory device. The memory device 214 typically includes at least some form of computer-readable media. Computer readable media include any available media that can be accessed by the computing device 104. By way of example, computer-readable media can include computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory and other memory technology, compact disc read only memory, blue ray discs, digital versatile discs or other optical storage, magnetic cassettes, magnetic tape, magnetic disk storage or other magnetic storage devices, or any other medium that can be accessed by the computing device 104. In some embodiments, computer readable storage media is non-transitory computer readable storage media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The network communication device 216 is a device that operates to communicate data across the network 230. The network communication device 216 allows the computing device 104 to communicate with remote devices, such as with the wire product conversion server 240. Examples of the network communication device 216 include wired and wireless data communication devices, such as a cellular, WIFI, BLUETOOTH™, LoRa, and wired (e.g., Ethernet) communication device.

In embodiments, the visual output device 218 includes one or more light-emitting devices that generate a visual output. Examples of the visual output device 218 include a display device (which can include a touch-sensitive display device) and lights such as one-or-more light-emitting diodes (LEDs). The visual output device 218 may operate to display the wire product conversion user interface 106 to a user.

In example embodiments, the visual output device 218 may additionally operate as an input device, such as in embodiments in which the visual output device 218 includes a touch-sensitive display device. In these embodiments, inputs defining a conversion type may be received through the conversion type control 220 of the wire product conversion user interface 106 using the visual output device 218. Similarly, product characteristics may be received through the product characteristics control 222 and installation conditions may be received through the installation conditions control 224 using the visual output device 218.

In alternative embodiments, the computing device 104 may include a separate input device for receiving inputs. For example, the computing device 104 may include an input device including a keyboard and mouse.

In the illustrated embodiment, the wire product conversion server 240 similarly includes a processing device 242, a memory device 244, and a network communication device 246. In an example, the processing device 242, the memory device 244, and the network communication device 246 may be similar to the processing device 212, the memory device 214, and the network communication device 216 respectively, which have been previously described.

The wire product conversion server 240 may additionally include a wire product conversion engine 250. In examples, the wire product conversion engine 250 includes an attribute calculator 252 and a wire product mapper 254. In some embodiments, the wire product conversion engine 250 may additionally include a wire product filter 256. In an embodiment, the wire product conversion engine 250 generates the wire product conversion user interface 106 to be presented at the computing device 104.

As described further herein, the attribute calculator 252 determines an attribute of a baseline wire product, such as an ampacity. In an example, the baseline wire product may be determined based on the conversion type and the product characteristics input through the conversion type control 220 and the product characteristics control 222 of the wire product conversion user interface 106.

The wire product mapper 254 may determine the converted wire products 226 based on the attribute of the baseline wire product determined by the attribute calculator 252. For example, the wire product mapper 254 may determine wire products that have the same or a similar ampacity to the ampacity of the baseline wire product.

The wire product filter 256 may analyze the converted wire products 226 output by the wire product mapper 254 and determine if any of the converted wire products 226 are not compatible or suitable for the wiring project of the user. For example, the wire product filter 256 may remove wire products that are incompatible based on installation conditions input through the installation conditions control 224 of the wire product conversion user interface 106. In another example, the wire product filter 256 may generate warnings for wire products that are incompatible with the installation conditions.

In embodiments, the wire product conversion server 240 is connected to a wire product database 260. In embodiments, the wire product database 260 maintains product specifications 262. The wire product database 260 may also maintain product constraints 264. In an example, the product specifications 262 are used by the attribute calculator to determine the attribute (e.g., the ampacity) of the baseline wire product. The product specifications 262 may also be used by the wire product mapper 254 to determine the converted wire products 226. In some embodiments, the wire product filter 256 may use the product specifications 262 and the product constraints 264 to filter the converted wire products 226.

Although the wire product database 260 is shown separately from the wire product conversion server 240 in the illustrated embodiment, in some embodiments, the wire product database 260 may be a component of the wire product conversion server 240. For example, the information maintained in the wire product database 260 (e.g., the product specifications 262 and the product constraints 264) may be stored in the memory device 244 of the wire product conversion server 240.

Additionally, in some embodiments, any one or more of the functions, methods, and operations described herein as being performed by the wire product conversion server 240—or components of the wire product conversion server 240, such as the wire product conversion engine 250—can alternatively be performed on the computing device 104. For example, in an embodiment, the computing device 104 may include a wire product conversion application for determining converted wire products. In this example, the wire product conversion application may perform the functions of the wire product conversion engine 250 (i.e., the functions of the attribute calculator 252, the wire product mapper 254, and the wire product filter 256). Similarly, the information maintained in the wire product database 260 (i.e., the product specifications 262 and the product constraints 264) may be maintained on the computing device (e.g., in the memory device 214).

In various embodiments, the network 230 includes one or more data communication links, which may include multiple different types. For example, the network 230, can include wired and/or wireless links, including BLUETOOTH™, ultra-wideband (UWB), 802.11, ZigBee, cellular, LoRa, and other types of wireless links. Furthermore, in various embodiments, the network 230 is implemented at various scales. For example, the network 230 can be implemented as one or more local area networks (LANs), metropolitan area networks, subnets, wide area networks (such as the Internet), or can be implemented at another scale. Further, in some embodiments, the network 230 includes multiple networks, which may be of the same type or of multiple different types.

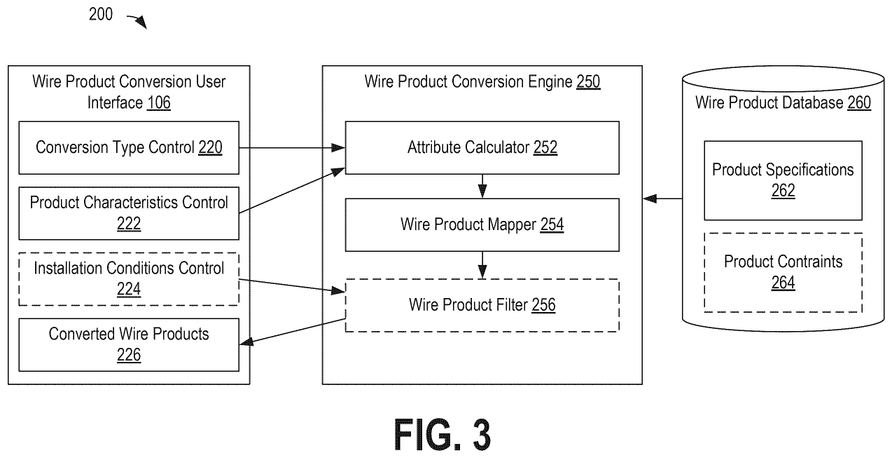

FIG. 3 illustrates another example of the system 200 for determining converted wire products. In the example illustrated in FIG. 3, the flow of information between the components of the system 200 is shown.

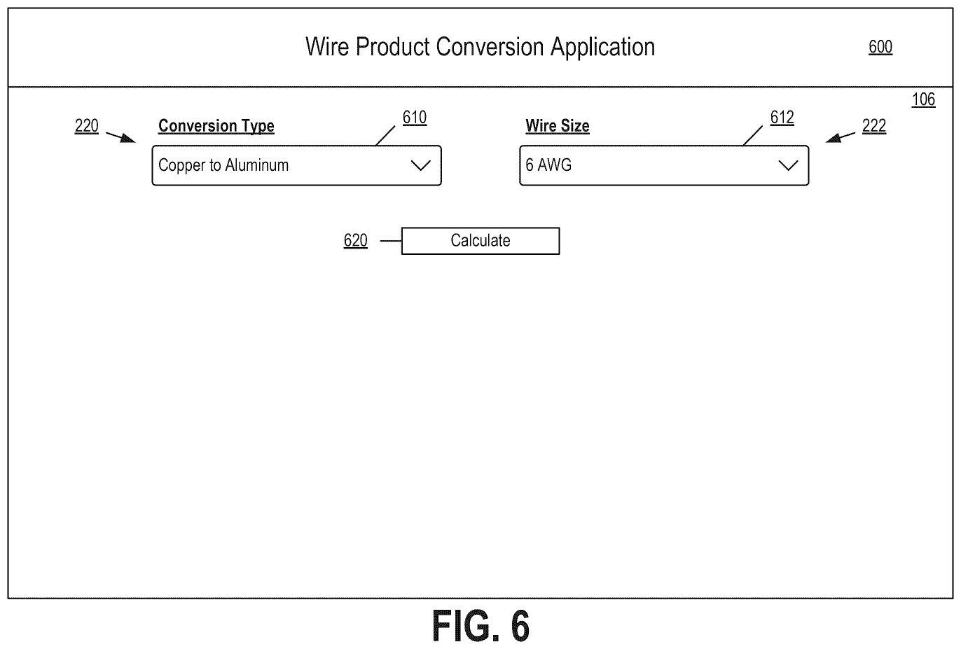

As described briefly above, a conversion type and product characteristics may be used to determine one or more converted wire products 226. A wire product conversion user interface 106 may include a conversion type control 220 and a product characteristics control 222 for receiving inputs from the user defining the conversion type and the product characteristics. In an example, the conversion type includes at least a baseline conductor material. For example, the conversion type may include a baseline conductor material and a conductor material to which the wire product will be converted. In an example, the product characteristics define characteristics of a baseline wire product, such as a size of the baseline wire product. In other examples, other information about the baseline wire product may be included in the product characteristics, such as a type of the baseline wire product (e.g., THHN, XHHW-2, etc.) or other details about the baseline wire product. An example of the conversion type control 220 and the product characteristics control 222 are described further herein, particularly with respect to FIGS. 6-14.

The attribute calculator 252 may use the conversion type and the product characteristics to determine an attribute of the baseline wire product. In examples, the attribute determined by the attribute calculator 252 may be an electrical attribute of the baseline wire product, such as an ampacity of the baseline wire product. In other examples, the attribute of the baseline wire product may be a mechanical attribute, such as a weight, a voltage drop, a rated breaking strength, or the like. In some examples, the attribute calculator 252 may determine multiple attributes of the baseline wire product. For example, the attribute calculator 252 may determine both an ampacity of the baseline wire product and a rated breaking strength of the baseline wire product. In embodiments, the attribute determined by the attribute calculator 252 may be determined based on a type of the wire product (e.g., building wire products, overhead wire products, etc.).

In embodiments, using the baseline conductor material specified by the conversion type and the wire product size specified by the product characteristics, the attribute calculator 252 may determine the baseline wire product. The product specifications 262 maintained in the wire product database 260 can then be used by the attribute calculator 252 to determine the attribute (e.g., ampacity) of the baseline wire product. In an example, the ampacities of wire products are specified by the National Electrical Code—e.g., the National Electrical Code Table 310.16 which includes ampacities of insulated conductors in raceway, cable, or Earth when directly buried. The product specifications 262 may include the ampacities of the wire products, and the attribute calculator 252 can identify the ampacity of the baseline wire product accordingly. Other attributes may similarly be determined by the attribute calculator 252.

In an example, as described above, the baseline wire product may be identified as a 6 AWG, copper conductor wire product. Using the product specifications 262, the attribute calculator 252 may determine that the ampacity of the baseline wire product at 75 °C is 65 amps. In some embodiments, the attribute calculator 252 may additionally or alternatively determine the ampacity of the baseline wire product at other temperatures, such as 90 °C or 105 °C. Similarly, in some examples, the ampacities may be based on installation conditions of the wire product, such as where the wire product is installed (e.g., ampacity in duct or ampacity in air), number of current-carrying conductors, raceway or bundling effects, or the like. In some examples, ampacity correction factors may be defined by the NEC—e.g., Tables 310.15(B)(1) and 310.15(C) (1) may provide example correction factors based on ambient temperature and conductor bundling, respectively, that may be applied when determining ampacities of wire products.

In some examples, the attribute calculator 252 may calculate the attribute of the baseline wire product based on the product specifications 262. For example, the attribute calculator 252 may calculate a voltage drop (e.g., a voltage drop over 1000 feet) for the baseline wire product based on information included in the product specification 262, such as a resistance (e.g., a DC or AC resistance) of the baseline wire product. In some examples, a predetermined current may be used to calculate the voltage drop.

Using the attribute (e.g., ampacity) of the baseline wire product, the wire product mapper 254 determines the converted wire products 226. For example, using the product specifications 262, the wire product mapper 254 may identify other wire products that have the conductor material identified in the conversion type and have the same ampacity. For example, the wire product mapper 254 may identify wire products with an aluminum conductor that have an ampacity of 65 amps at 75 °C. As described above, in this example, the wire product mapper 254 may identify 4 AWG, aluminum conductor wire products as the converted wire products 226. In other examples, the converted wire products 226 may include wire products that have the closest ampacity to the baseline wire product—e.g., if no wire products with the conductor material identified in the conversion type have the same ampacity as the baseline wire product. The converted wire products 226 identified by the wire product mapper 254 may then be presented in the wire product conversion user interface 106. In some embodiments, correction factors may be applied to the ampacities of the converted wire products 226, similar to as is described above with the baseline wire products. In examples, by applying correction factors, the attribute calculator 252 can validate that the converted wire product maintains a code-compliant ampacity under real-world installation conditions, rather than relying solely on base ampacity values. This is particularly relevant in derating-sensitive applications such as data centers, industrial plants, and cable tray systems.

As described above, in some examples, there may not be any wire products with a similar ampacity to the baseline wire product. In these cases, the wire conversion user interface 106 may present an indication that there are not converted wire products 226 available.

While the above example describes using ampacity as the attribute to determine the converted wire products 226, in other examples, any attribute of the baseline wire product may be used to determine the converted wire products. For example, a weight or diameter of the baseline wire product may be used to determine converted wire products 226 having corresponding weights or diameters.

In some embodiments, installation conditions may be used to filter the converted wire products 226. In an embodiment, the installation conditions are input through an installation conditions control 224 on the wire product conversion user interface 106. A wire product filter 256 may use the installation conditions to filter the converted wire products by the wire product mapper 254.

In an embodiment, the wire product filter 256 uses product constraints 264 maintained in the wire product database 260 to filter out converted wire products that are not compatible with the identified installation conditions. In an example, the installation conditions may identify that the wire products will be used for wastewater treatment. Using the product constraints 264, the wire product filter 256 may determine that wire products with an aluminum conductor are not meant to be used for wastewater treatment due to corrosion and oxidation that may occur with aluminum. Accordingly, if the converted wire products 226 include wire products with aluminum conductors, the wire product filter 256 may remove the wire products with aluminum conductors from the converted wire products 226.

In some embodiments, the wire product filter 256 may additionally or alternatively use the product specifications 262 to filter the converted wire products. For example, the installation conditions may identify a size of a conduit or other cable pathway or raceway in which the wire product will be installed. Using the product specifications 262, the wire product filter 256 may filter out converted wire products that do not fit in the identified conduits—e.g., because a diameter of the wire product is too large to fit in the conduit. Similarly, a shape of a conduit and a minimum bending radius of the wire products may be used to filter out converted wire products that do not fit in the identified conduits—e.g., because a bend radius of the wire product is not compatible with a shape of the conduit.

In other embodiments, rather than remove the incompatible wire products, the wire product filter 256 may generate a warning that is displayed in the wire product conversion user interface 106 alongside the converted wire products 226. For example, the warning may indicate that the converted wire products 226 include products that are not compatible with the identified installation conditions.

In other examples, other installation conditions may be used to filter the converted wire products 226. For example, whether the wire product will be buried directly in the ground may be an installation condition that is considered when filtering the converted wire products 226. In examples, the installation conditions may include one or more of an intended use of the wire product, an environment in which the wire product will be used, or a size of a conduit into which the wire product will be installed. The installation conditions control 224 may be adjusted accordingly depending on the relevant installation condition to be considered.

In some embodiments, the attribute calculator 252, wire product mapper 254, and wire product filter 256 collectively implement a specific technical architecture that transforms user-supplied inputs into dynamically computed, code-compliant conductor substitutions. This architecture is not directed to abstract mathematical operations that could be performed by a person reviewing tables, nor to the mere display of pre-stored lookup results. Rather, the claimed system performs a real-time, multi-step technical computation that integrates heterogeneous data sources—e.g., NEC ampacity tables, manufacturer-specified physical dimensions, installation constraint databases, and real-time commodity pricing data—within a unified computational framework. The output of this computation: a validated, installation-aware, code-compliant conductor substitution recommendation, is a concrete, technical result that improves the functioning of the computing system by eliminating redundant recalculation, reducing inconsistency, and enabling deterministic code-compliance outputs.

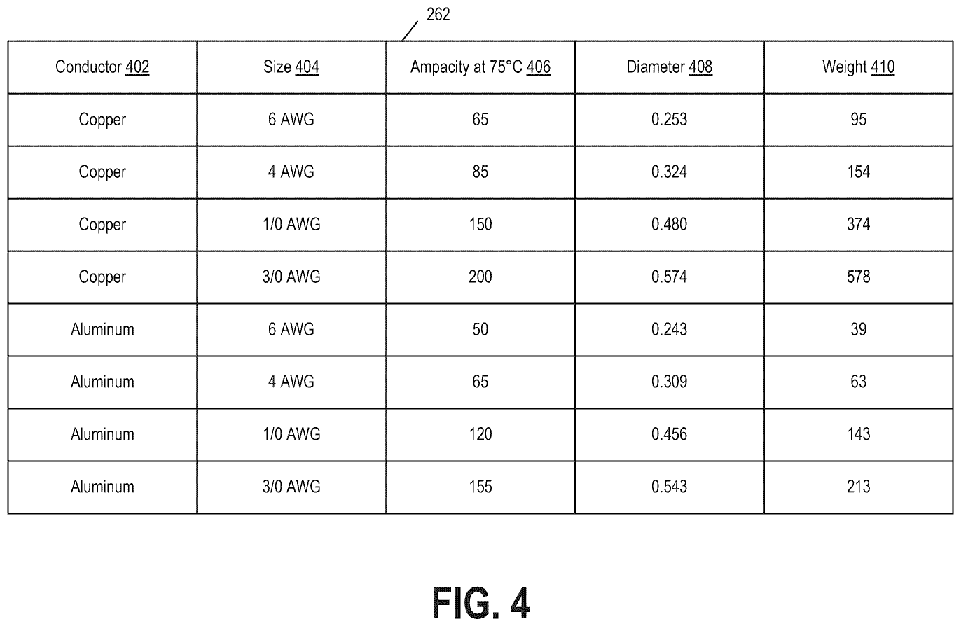

FIG. 4 illustrates example product specifications 262 that may be maintained by the wire product database 260. In the illustrated example, the product specifications 262 include specifications for a plurality of wire products, including a conductor material 402, a size 404, an ampacity at 75 °C 406, a diameter 408, and a weight 410. In further embodiments, additional or alternative information may be included with the product specifications 262, such as a rated breaking strength or a minimum bending radius. In an embodiment, the product specifications 262 are determined using values provided by industry-accepted sources, including the National Electrical Code (NEC) and American Society for Testing and Materials (ASTM) standards. Examples of ASTM standards include ASTM B8 Concentric-Lay-Stranded Copper Conductors, ASTM B801 Concentric-Lay-Stranded Conductors of 8000 Series Aluminum Alloy, and other similar standards. In an example, the ampacities 406 are defined by the National Electrical Code. In other embodiments, the product specifications 262 may be defined by the manufacturer of the wire products. For example, the diameters 408 of the wire products may be determined by the manufacturer of the wire products.

In the illustrated example, the product specifications 262 include specifications for building wire products. For example, the product specifications 262 may include specifications for THHN wire products. In other embodiments, the product specifications 262 may include specifications for other building wire products, including XHHW wire products. Similarly, the product specifications 262 may include specifications for other types of wire products, including overhead wire products, industrial wire products, and automotive wire products. The specifications included in the wire product specifications 262 may depend on the type of wire products included therein—i.e., different specifications may be included for building wire products and overhead wire products.

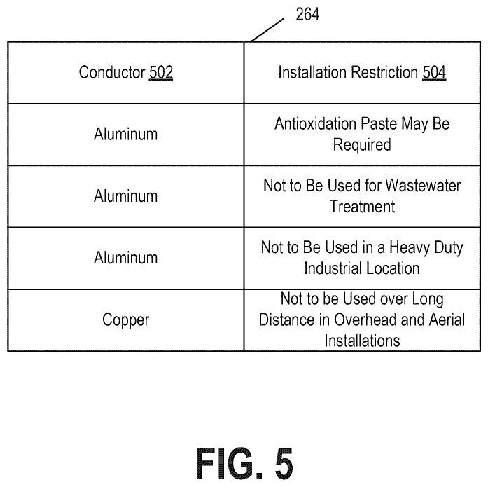

FIG. 5 illustrates example product constraints 264 that may be maintained by the wire product database 260. As described above, the product constraints 264 may be used to filter converted wire products that are not compatible with installation conditions. Accordingly, the product constraints 264 may include associations between conductor material 502 and installation restrictions 504. For example, as identified in the illustrated example, the product constraints 264 identify that wire products with an aluminum conductor are not to be used for wastewater treatment. Other examples of product constraints 264 include an indication that aluminum wire products require antioxidation paste (which increases the overall cost of using the aluminum wire products), an indication that aluminum wire products are not to be used in a heavy duty industrial location (e.g., hazardous locations or areas with harsh environmental elements), and an indication that copper wire products are not to be used over long distances due to the higher weight compared to other (e.g., aluminum) wire products.

While the illustrated example shows some installation restrictions 504 that may be considered, in other examples, additional or alternative installation restrictions 504 may be included in the product constraints 264. For example, the product constraints 264 may indicate that aluminum wire products are not to be used in areas with high saltwater content.

While the illustrated examples include installation restrictions 504 based on a conductor material 502, in alternative examples, the product constraints 264 may additionally or alternatively include installation restrictions 504 associated with other characteristics of a wire product, including the size, weight, diameter, and insulation.

FIGS. 6-14 illustrate examples of wire product conversion user interfaces 106. In embodiments, the wire product conversion user interface 106 is presented in a wire product conversion application 600. In alternative examples, the wire product conversion user interface 106 is presented in a browser. The wire product conversion user interface 106 described herein is not merely a display interface but functions as an input/output mechanism tightly coupled to the underlying computational pipeline described above. For example, inputs received via the wire product conversion user interface 106 may directly parameterize the attribute calculation and constraint filtering operations, and the resulting outputs may reflect dynamically computed technical evaluations rather than pre-stored results.

FIGS. 6-8 illustrate an example of the wire product conversion user interface as a user enters a conversion type and product characteristics. As described above, in an example, the wire product conversion user interface 106 includes a conversion type control 220 for receiving inputs defining a conversion type and a product characteristics control 222 for receiving inputs defining product characteristics.

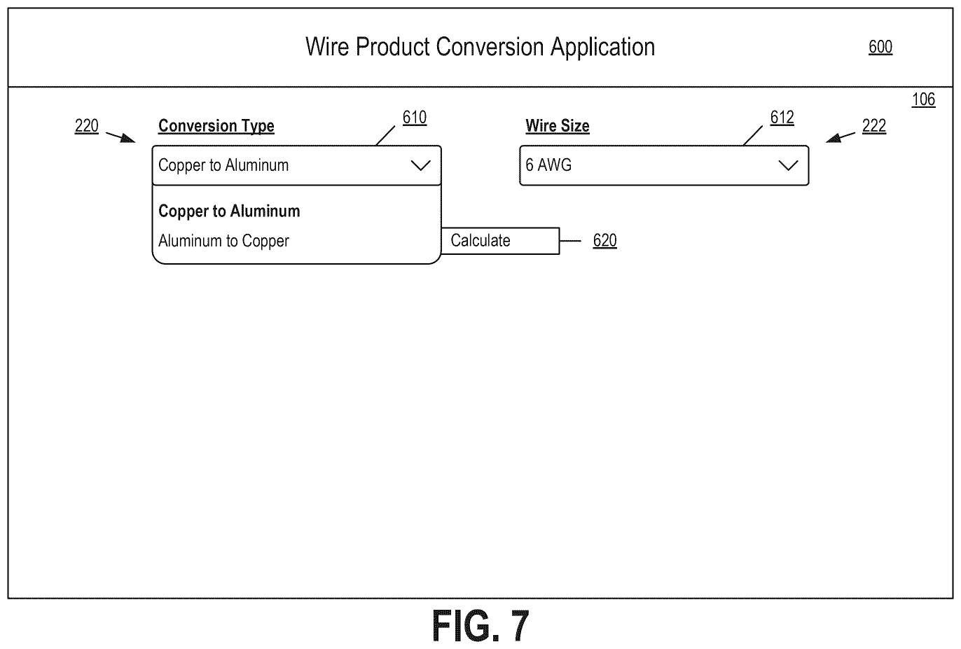

In the illustrated example, the conversion type control 220 includes a drop-down menu 610 to select the conversion type from a plurality of conversion types. In examples, the conversion types define a conversion from a first conductor material (i.e., a conductor material of a baseline wire product) to a second conductor material. For example, as shown in FIG. 7, the drop-down menu 610 may allow the user to select either a copper to aluminum conversion or an aluminum to copper conversion. In other embodiments, the drop-down menu 610 may allow the user to select additional or alternative conversions between conductor materials. For example, the conversion types may include conversions between any of copper, aluminum, and steel. Additionally, while the illustrated example shows the conversion types that include conversions to a single second conductor material, in some examples, multiple second conductor materials may be selected. For example, the conversion type may include a conversion from copper to aluminum and steel. Similarly, while the illustrated example shows the conversion type control 220 including the drop-down menu 610, in alternative embodiments, the conversion type control 220 may include additional or alternative user interface elements for defining the conversion type.

In some embodiments, rather than the conversion types defining both a first conductor material—the baseline conductor material—and a second conductor material, the conversion type may just define the baseline conductor material, and the second conductor material may automatically be determined based on the baseline conductor material. In some examples, the second conductor material may be further determined based on product characteristics defined by an input at the product characteristics control 222.

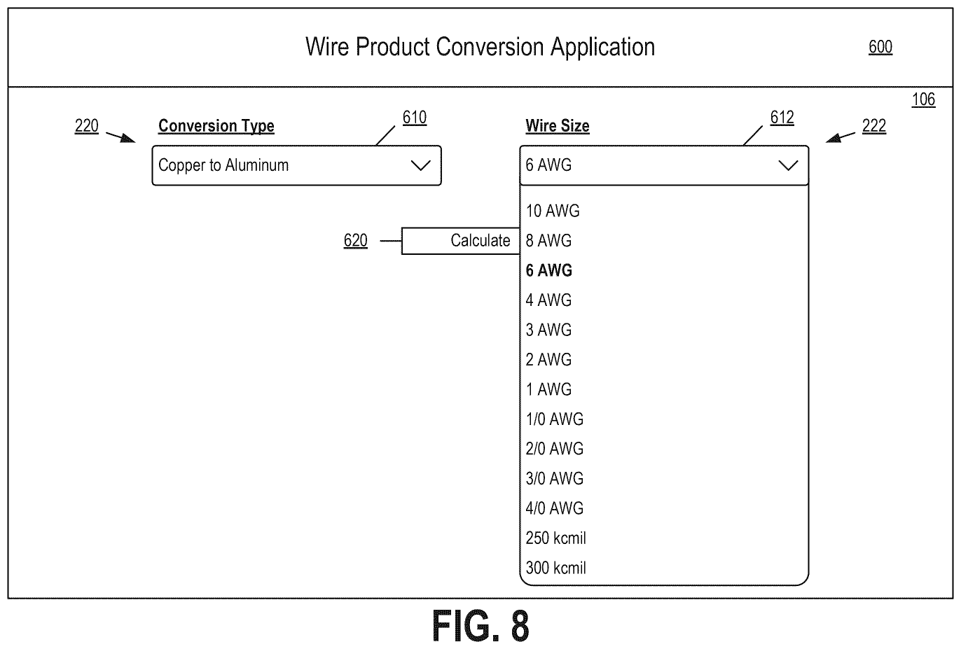

In the illustrated example, the product characteristics control 222 includes a drop-down menu 612 to select a size of the baseline wire product. Example sizes are shown in FIG. 8. In further examples, additional or alternative sizes may be options in the drop-down menu 612. Similarly, while the illustrated example shows options to select the wire size with the product characteristics control 222, in alternative examples, additional or alternative product characteristics may be defined with the product characteristics control 222, including an insulation type (e.g., THHN) or any other characteristic for a wire product.

As described above, based on the conversion type and the product characteristics defined by the inputs to the conversion type control 220 and the product characteristics control 222, one or more converted wire products may be identified. After inputting the conversion type and product characteristics, the user may select an option 620 to determine the converted wire products. In alternative examples, the converted wire products may automatically be determined after both the conversion type and product characteristics are input at the conversion type control 220 and the product characteristics control 222.

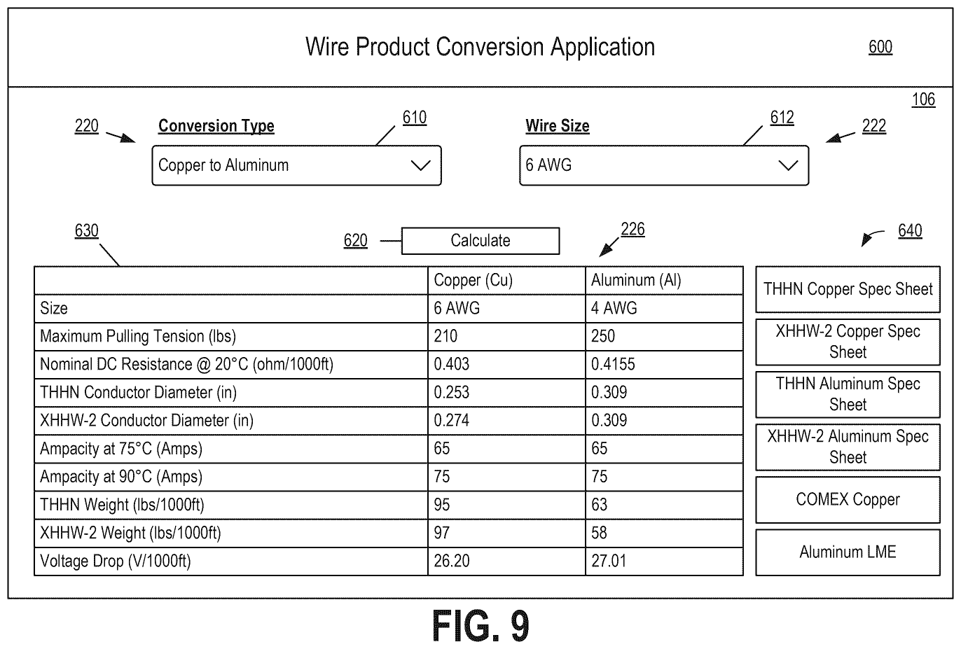

FIG. 9 illustrates an example of the wire product conversion user interface 106 presenting converted wire products 226. In the illustrated example, the one or more converted wire products 226 are presented in a table 630 which lists the baseline wire product and the converted wire products 226. In the illustrated example, based on the conversion type and the product characteristics input, the baseline wire product is determined to be a 6 AWG, copper conductor wire product and the converted wire product 226 is determined to be a 4 AWG, aluminum conductor wire product. The table 630 may further include other details about the baseline wire product and the converted wire product 226, such as a maximum pulling tension, a nominal DC resistance, a diameter, an ampacity, a weight, and a voltage drop. In some embodiments, additional or alternative details may be included in the table 630 comparing the baseline wire product to the converted wire product 226. For example, percent differences in one or more of the values may be presented in the table 630—e.g., the table 630 may indicate that the diameter of the 4 AWG THHN aluminum conductor wire product is 22.1% larger than the diameter of the 6 AWG THHN copper conductor wire product. Similarly, the table 630 may show percent differences in the weights of the wire products—e.g., the table 630 may indicate that the 4 AWG THHN aluminum conductor wire product is 33.7% lighter than the 6 AWG THHN copper conductor wire product, even though the aluminum conductor wire product is larger (i.e., has a larger diameter) than the copper conductor wire product. In some examples, the wire product conversion user interface 106 may include an explanation of the benefits in the different wire products. For example, the wire product conversion user interface 106 may explain mechanical, logistical, and cost implications of the qualities of the different wire products.

In examples, the details about the baseline wire product and the converted wire product 226 are provided by industry-accepted sources, including the National Electrical Code and ASTM standards, and manufacturers of the wire products. Using the information about the baseline wire product and the converted wire product 226, a user can easily determine which of the wire products is better suited to their needs. For example, because converted wire product 226 (i.e., the 4 AWG, aluminum conductor wire product) is lighter, the user may decide that the converted wire product 226 is better for their project. Alternatively, in another example, because the baseline wire product (i.e., the 6 AWG, copper conductor wire product) has a smaller diameter, the user may decide that the baseline wire product is better for their project. Further, after analyzing the baseline wire product and the converted wire product 226, the user may use a wire product reliability comparison system to determine if other similar wire products may be more reliable than the baseline wire product or the converted wire product 226. An example wire product reliability comparison system is described in U.S. Provisional Patent Application No. 63/713,969, filed Oct. 30, 2024, and entitled “Wire Product Reliability Comparison System and Method,” the disclosure of which is hereby incorporated in its entirety.

In the illustrated embodiment, the wire product conversion user interface 106 further includes links 640 to additional resources related to the baseline wire product and the converted wire product 226. For examples, links to specification sheets associated with the baseline wire product and the converted wire product 226 may be provided. Additionally, links to exchanges related to futures contracts and options contracts associated with the conductor materials (e.g., Copper COMEX and Aluminum LME) may be provided so that a user can see how prices of the conductor materials are trending. Users may use the price history shown through the exchanges to see trends in the pricing of the conductor materials. In some embodiments, additional or alternative information may be included as well, including information about tariffs or other factors that may impact the price of the wire products or components thereof.

In some embodiments, in addition to or alternative to presenting the links 640 to the additional information, the additional information may be included in the wire product conversion user interface 106. For example, a price or a trend of the price for a conductor material for the baseline wire product or the converted wire product 226 may be included in the table 630.

In some embodiments, additional or alternative information may be presented in the wire product conversion user interface 106. For example, reminders related to operation or maintenance of the baseline wire product or the converted wire products 226 may be presented on the wire product user interface 106. For example, when an aluminum conductor wire product is identified as a converted wire product, the wire product conversion user interface 106 may present guidance indicating that antioxidant compound should be applied at all terminations. Improper termination of aluminum conductors is a common source of installation failure; accordingly, the system may present reminders reflecting industry-accepted best practices—such as those recommended by the National Electrical Contractors Association (NECA) or conductor manufacturers—to reduce installation errors and support approval by the authority having jurisdiction.

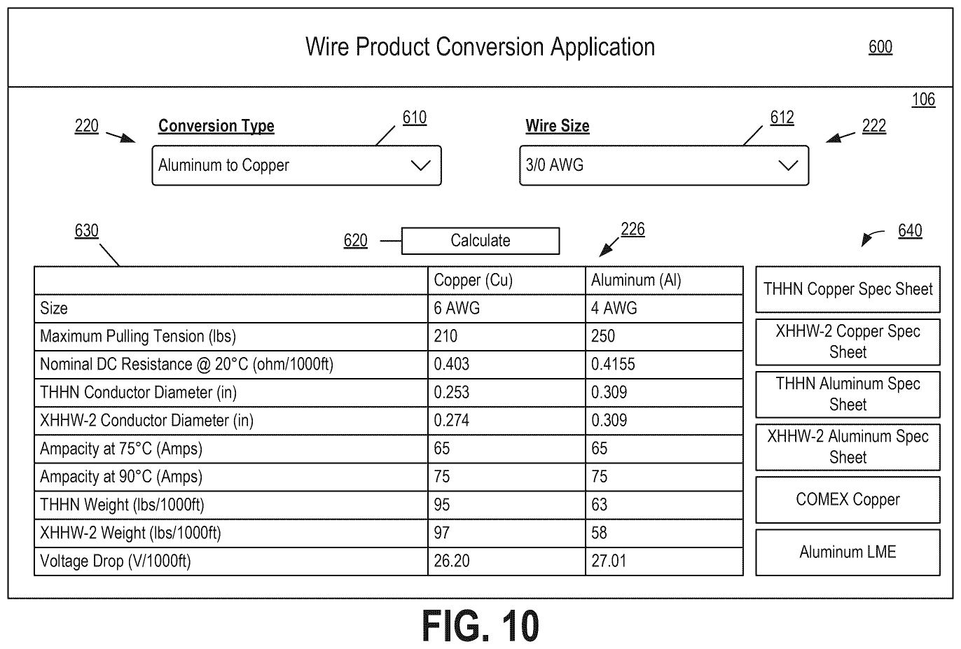

FIG. 10 illustrates an additional example of the wire product conversion user interface 106 presenting converted wire products 226. In the illustrated example, a different conversion type and different product characteristics are input compared to the example shown in FIGS. 6-9. Accordingly, as seen in the table 630, the baseline wire product and converted wire products 226 are different in this example. While the baseline wire product and converted wire products 226 may be different, similar information may be presented in the table 630, and similar links 640 may be presented. In alternative embodiments, the information presented in the table 630 and the links 640 presented may depend on the baseline wire product or the converted wire products 226.

Additionally, as shown in the illustrated example, the one or more converted wire products 226 may not have the same ampacity as the baseline wire product. In some embodiments, as described above, the converted wire products 226 may include the wire products with the conductor material specified in the conversion type that have the closest ampacities to the baseline wire product.

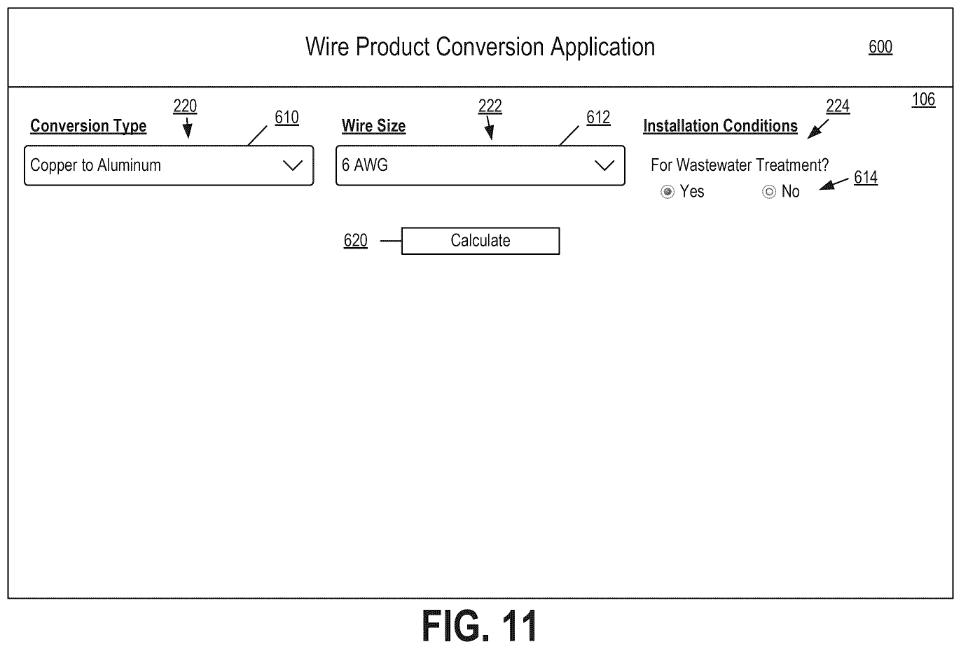

FIGS. 11-14 illustrate examples of filtering converted wire products based on installation conditions. In these examples, the wire product conversion user interface 106 includes an installation conditions control 224 through which a user can input installation conditions.

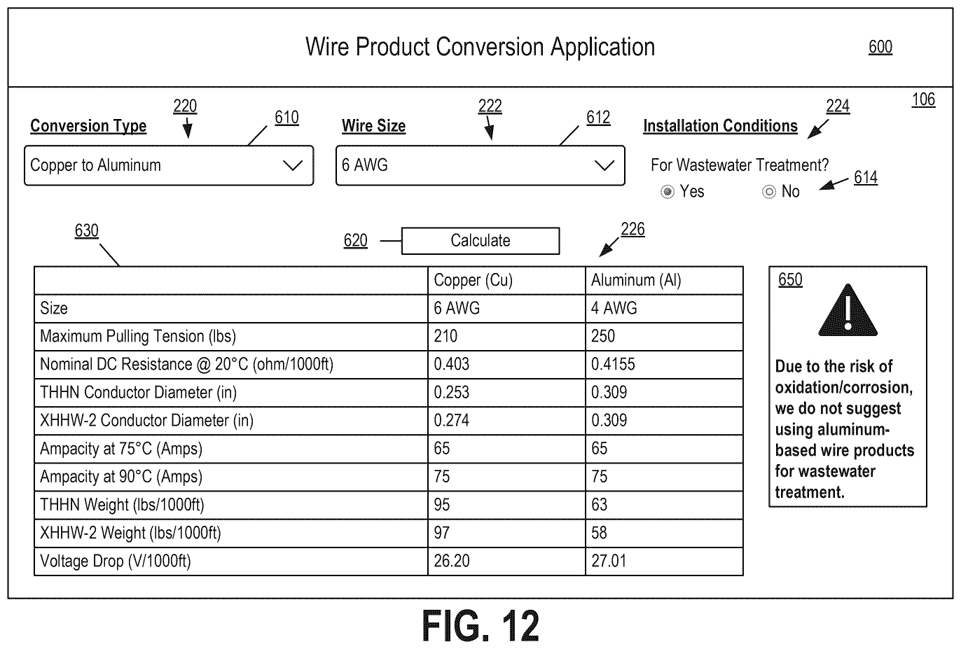

FIGS. 11 and 12 illustrate a first example of filtering based on installation conditions. In the illustrated example, the converted wire products are filtered based on a use of the wire products. In this example, the installation conditions control 224 includes an option 614 to indicate whether the wire product is intended to be used in wastewater treatment.

As shown in FIG. 12, a warning 650 may be presented based on the installation conditions—i.e., whether the wire product is intended to be used in wastewater treatment. As described above in connection with FIG. 5, aluminum conductor wire products may not be intended for use with wastewater treatment due to the risk of oxidation and corrosion to the aluminum. Accordingly, in this example, the warning 650 may include a statement to recommend to the user not to use aluminum wire products based on the installation conditions, even though the converted wire products include aluminum wire products.

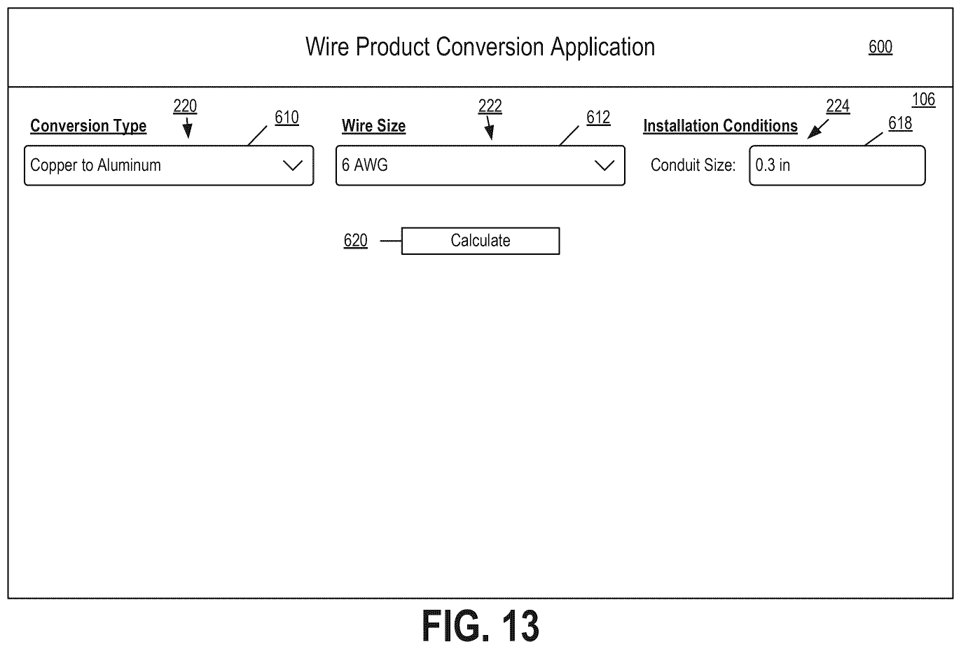

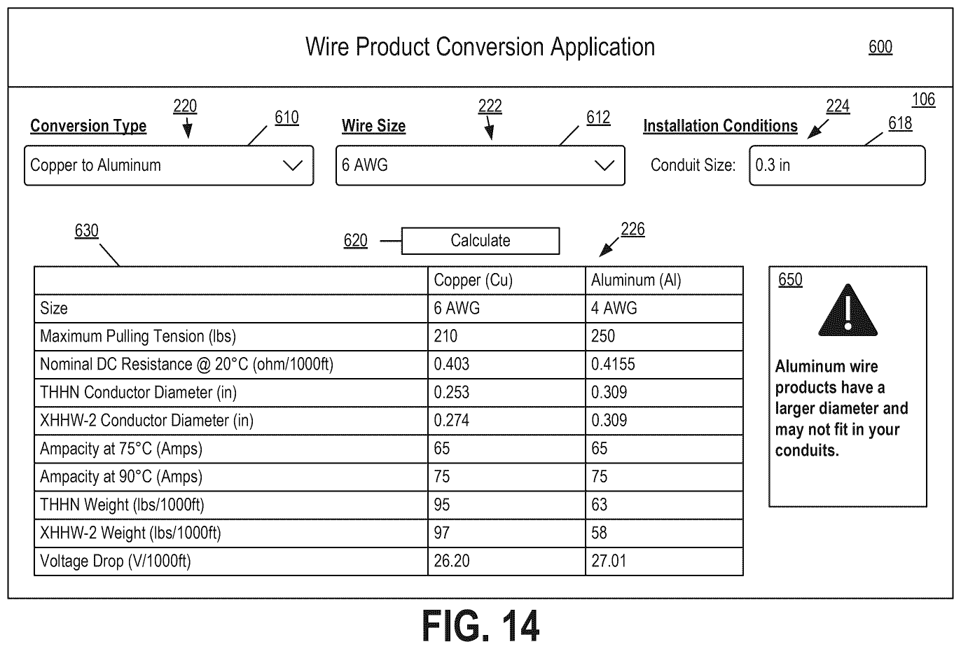

FIGS. 13 and 14 illustrate a second example of filtering based on installation conditions. In the illustrated example, the wire products are filtered based on a conduit size into which the wire products will be installed. In this example, the installation conditions control 224 includes an input to define a size (e.g., a diameter) of the conduit into which the wire products will be installed.

As shown in FIG. 14, the warning 650 may be presented based on the installation conditions—i.e., the size of the conduit into which the wire product will be installed. In this example, a diameter of the baseline wire product and the converted wire product 226 are compared against the input conduit size to determine if the wire product will fit in the conduit. As shown in the illustrated example, the aluminum wire product is too large to fit in the conduit. Accordingly, the warning 650 may include a statement to recommend to the user not to use the aluminum wire product even though the aluminum wire product is the converted wire product. In a similar example, the warning 650 may indicate that the aluminum wire product may not fit in a conduit based on a minimum bending radius of the aluminum wire product.

While the illustrated examples show presenting warning messages based on the installation conditions input into the installation conditions control 224, in alternative embodiments, the wire products that are not compatible with the installation conditions may be removed from the converted wire products 226—i.e., the incompatible wire products may not be shown in the table 630. For example, in the example shown in FIG. 14, the table 630 may include only the copper wire products and not the aluminum wire products based on the aluminum wire products being incompatible with the input conduit size.

Similarly, while the illustrated examples show the installation conditions considered including whether the wire product will be used for wastewater treatment and a size of a conduit into which the wire product will be installed, in other examples, other installation conditions may be considered. For example, whether the wire product will be installed directly in the ground may be an installation condition that is considered.

Further, while the illustrated examples show the warnings 650 presented based on user-entered installation conditions, in other examples, warnings 650 may be presented even if the user does not provide the installation conditions. For example, the warnings 650 may remind the user that aluminum wire products are larger and have a larger minimum bending radius than the corresponding copper wire products and help the user plan for pull boxes, raceways, and the like should the user choose to use the aluminum wire products. Similarly, warnings 650 may be presented to remind users about the use of antioxidant compounds with aluminum wire products.

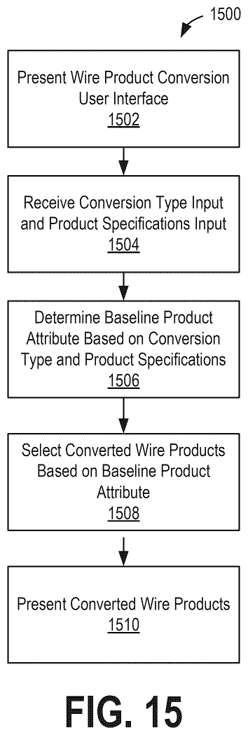

FIG. 15 illustrates a flowchart of an example method 1500 for converting wire products. In the illustrated example, the method 1500 includes operations 1502, 1504, 1506, 1508, 1510. In an example, the method 1500 may be performed by a wire product conversion engine, as described above.

The operation 1502 includes presenting a wire product conversion user interface. In embodiments, the wire product conversion user interface is presented to a user looking for a wire product for a wiring project. In an example, the wire product conversion user interface includes a conversion type control and a product characteristics control for receiving user inputs. In an embodiment, the wire product conversion user interface is presented on a computing device, such as in a browser or in a wire product conversion application.

In some embodiments, the wire product conversion user interface is generated by a wire product conversion server, which is then provided to the computing device. In alternative embodiments, the wire product conversion user interface is generated by the computing device.

The operation 1504 includes receiving a conversion type input and product characteristics input. In an example, the conversion type input defines a conversion type (e.g., copper to aluminum), and the product characteristics define one or more characteristics of a baseline wire product (e.g., a size of the baseline wire product).

In an embodiment, the conversion type is input by the user into the conversion type control of the wire product conversion user interface. Similarly, in an embodiment, the product characteristics are input by the user into the product characteristics control of the wire product conversion user interface. The inputs may then be transmitted to the wire product conversion server.

The operation 1506 includes determining an attribute of the baseline wire product based on the conversion type and the product characteristics. In an example, a conductor material of the baseline wire product is determined using the input conversion type and other characteristics of the baseline wire product are determined using the input product characteristics. Using the product characteristics, an attribute of a wire product having the product characteristics may be determined. For example, an ampacity of a wire product having the characteristics of the baseline wire product may be determined. In other examples, other attributes may be determined, including other electrical attributes of the baseline wire product or mechanical attributes of the baseline wire product (e.g., a rated breaking strength or a weight). In further examples, multiple attributes may be determined, such as an ampacity and a rated breaking strength.

In an embodiment, a wire product database may maintain a list of wire products and their associated specifications, including the ampacities and other attributes of the wire products. The ampacity or other attribute of the baseline wire product may be determined using the stored product specifications.

The operation 1508 includes selecting one or more converted wire products based on the attribute of the baseline wire product. For example, as described above, the attribute may be the ampacity of the baseline wire product. In an example, the converted wire products include wire products having a conductor material as specified by the conversion type and an ampacity that is the same as the baseline wire product. In some examples, there may not be a wire product with the requisite conductor material that has an ampacity that is equal to the ampacity of the baseline wire product. In such examples, the converted wire products may include the wire products that have the requisite conductor material and the ampacities are the closest to the ampacity of the baseline wire product. In an embodiment, the converted wire products may be identified by analyzing the list of wire products maintained in the wire product database.

As described above, in some examples, multiple attributes of the baseline wire product may be determined, such as an ampacity and a rated breaking strength. In these examples, each of the attributes may be considered when determining the converted wire products.

The operation 1510 includes presenting the one or more converted wire products. In an example, the one or more converted wire products may be presented in the wire product conversion user interface. In an embodiment, the wire product conversion user interface is automatically updated with the one or more converted wire products.

As described above, the converted wire products may be presented in a table including specifications of the converted wire products and the baseline wire product. The user can view the table to quickly determine the differences between the baseline wire product and the converted wire product and determine which of the wire products best suits their needs.

In an embodiment, the computing device presents the converted wire products in the wire product conversion user interface. In an example, the wire product conversion server generates the updated wire product conversion user interface with the converted wire products and transmits the updated wire product conversion user interface to the computing device. In alternative embodiments, the computing device generates the updated wire product conversion user interface.

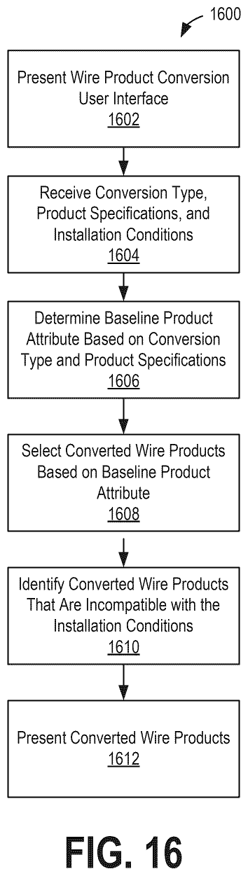

FIG. 16 illustrates a flowchart of another example method 1600 for converting wire products. In the illustrated example, the method 1600 includes operations 1602, 1604, 1606, 1608, 1610, 1612. In an example, the method 1600 may be performed by a wire product conversion engine, as described above.

The operation 1602 includes presenting a wire product conversion user interface. Like described above, the wire product conversion user interface may include a conversion type control and a product characteristics control. In an embodiment, the wire product conversion user interface may include an installation conditions control. In an embodiment, the wire product conversion user interface is presented on a computing device, such as in a browser or in a wire product conversion application.

In some embodiments, the wire product conversion user interface is generated by a wire product conversion server, which is then provided to the computing device. In alternative embodiments, the wire product conversion user interface is generated by the computing device.

The operation 1604 includes receiving a conversion type input, a product characteristics input, and an installation conditions input. As described above, the conversion type input defines a conversion type and the product characteristics define one or more characteristics of a baseline wire product. The installation conditions input may define characteristics of where the wire product will be used or installed. For example, the installation conditions may include an indication of whether the wire products will be used for wastewater treatment. In another example, the installation conditions may include a size of a conduit or other pathway into which the wire product will be installed.

In an embodiment, as described above, the conversion type is input by the user into the conversion type control of the wire product conversion user interface and the product characteristics are input by the user into the product characteristics control of the wire product conversion user interface. Similarly, the installation conditions may be input by the user into the installation conditions control of the wire product conversion user interface. The inputs may then be transmitted to the wire product conversion server.

The operation 1606 includes determining a baseline wire product attribute based on the conversion type and product characteristics. The operation 1606 may be similar to the operation 1506 described above in connection with FIG. 15.

The operation 1608 includes selecting one or more converted wire products based on the attribute of the baseline wire product. The operation 1608 may be similar to the operation 1508 described above in connection with FIG. 15.

The operation 1610 includes identifying converted wire products that are incompatible with the installation conditions. In an example, product constraints maintained in a wire product database may be used to identify converted wire products that are incompatible with the installation conditions. For example, if the installation conditions indicate that the wire products will be used for wastewater treatment, wire products with an aluminum conductor may be identified as being incompatible with the installation conditions.

Further, in some embodiments, product specifications maintained in the wire product database may be used to identify the converted wire products that are incompatible with the installation conditions. For example, the installation conditions may include a size of a conduit or other pathway into which the wire products will be installed. In this example, a diameter or other measurement of the converted wire products may be compared against the conduit size to determine if the converted wire products will fit in the specified conduits. Wire products that are too big to fit in the conduit may be identified as being incompatible with the installation conditions.

In some examples, the wire products that are incompatible with the installation conditions may be removed from the converted wire products. In alternative examples, the warnings may be generated to indicate that one or more of the converted wire products are incompatible with the installation conditions.

The operation 1612 includes presenting the one or more converted wire products. In an example, the one or more converted wire products may be presented in the wire product conversion user interface. In an embodiment, the wire product conversion user interface is automatically updated with the one or more converted wire products. In some examples, the converted wire products that are identified as incompatible with the installation conditions may not be presented during the operation 1612. In other examples, a warning is presented for the converted wire products that are identified as being incompatible with the installation conditions.

As described above, the converted wire products may be presented in a table including specifications of the converted wire products and the baseline wire product. The user can view the table to quickly determine the differences between the baseline wire product and the converted wire product and determine which of the wire products best suits their needs.

In an embodiment, the computing device presents the converted wire products in the wire product conversion user interface. In an example, the wire product conversion server generates the updated wire product conversion user interface with the converted wire products and transmits the updated wire product conversion user interface to the computing device. In alternative embodiments, the computing device generates the updated wire product conversion user interface.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A method for converting wire products, the method comprising:
presenting, at a computing device, a wire product conversion user interface, the wire product conversion user interface including a conversion type control and a product characteristics control;
receiving, via the conversion type control of the wire product conversion user interface at the computing device, a conversion type input including at least a conductor material of a baseline wire product;
receiving, via the product characteristics control of the wire product conversion user interface at the computing device, a product characteristic input including one or more characteristics of the baseline wire product;
based on the conversion type input and the product characteristic input, determining the baseline wire product;
determining an ampacity of the baseline wire product;
selecting one or more converted wire products based on the ampacity of the baseline wire product, wherein the one or more converted wire products have a different conductor material than the baseline wire product; and
presenting, via the wire product conversion user interface at the computing device, the one or more converted wire products.

2. The method of claim 1, wherein the one or more characteristics of the baseline wire product include a size of the baseline wire product.

3. The method of claim 1, wherein the wire product conversion user interface further includes an installation conditions input.

4. The method of claim 3, further comprising:
receiving, via the installation conditions input of the wire product conversion user interface at the computing device, an installation conditions input including an installation condition of a wire product;
determining, for each converted wire product of the one or more converted wire products, whether the converted wire product is compatible with the installation condition;
in response to a determination that the converted wire product is not compatible with the installation condition, generating a warning indicating that the converted wire product is not compatible with the installation condition; and
presenting, via the wire product conversion user interface at the computing device, the warning.

5. The method of claim 4, wherein the installation condition of the wire product includes one or more of an intended use of the wire product, an environment in which the wire product will be used, or a size of a conduit into which the wire product will be installed.

6. The method of claim 1, wherein the one or more converted wire products include a wire product having a same ampacity as the baseline wire product and the different conductor material.

7. The method of claim 1, wherein the one or more converted wire products include a wire product having a closest ampacity to the ampacity of the baseline wire product among wire products having the different conductor material.

8. The method of claim 1, wherein the wire product conversion user interface further presents one or more characteristics of the baseline wire product and one or more characteristics of the one or more converted wire products.

9. The method of claim 1, wherein the wire product conversion user interface further presents one or more links to resources associated with the baseline wire product and the one or more converted wire products.

10. The method of claim 9, wherein the one or more links include a link to an exchange of futures contracts and options contracts associated with the conductor material of the baseline wire product.

11. The method of claim 1, further comprising:
presenting, via the wire product conversion user interface at the computing device, one or more reminders related to one or more of operation or maintenance of the baseline wire product or the one or more converted wire products.

12. A wire product conversion system comprising:
one or more processors; and
one or more computer-readable storage devices storing data instructions that, when executed by the one or more processors, cause the wire product conversion system to:
generate a wire product conversion user interface, the wire product conversion user interface including a conversion type control and a product characteristics control;
provide the wire product conversion user interface to a computing device;
receive, via the wire product conversion user interface at the computing device, a request for converted wire products, the request including a conversion type and one or more product characteristics;
determine, based on the conversion type and the one or more product characteristics, a baseline wire product;
determine an attribute of the baseline wire product;
select, from a database, one or more converted wire products from a plurality of wire products based on the attribute of the baseline wire product, wherein the one or more converted wire products have a different conductor material than the baseline wire product;
in response to selecting the one or more converted wire products, automatically generate an updated wire product conversion user interface, the updated wire product conversion user interface including the one or more converted wire products; and
provide the updated wire product conversion user interface to the computing device.

13. The wire product conversion system of claim 12, wherein the attribute of the baseline wire product is an ampacity of the baseline wire product.

14. The wire product conversion system of claim 12, wherein the attribute of the baseline wire product is a rated breaking strength of the baseline wire product.

15. The wire product conversion system of claim 12, wherein the attribute of the baseline wire product is a weight of the baseline wire product.

16. The wire product conversion system of claim 12, wherein the wire product conversion user interface further includes an installation conditions input.

17. The wire product conversion system of claim 16, wherein the request further includes an installation condition; and
wherein the wire product conversion system is further configured to:
determine, for each converted wire product of the one or more converted wire products, whether the converted wire product is compatible with the installation condition; and
in response to a determination that the converted wire product is not compatible with the installation condition, generate a warning indicating that the converted wire product is not compatible with the installation condition,
wherein the updated wire product conversion user interface includes the warning.

18. A system for converting wire products, the system comprising:
one or more processors; and
one or more computer-readable storage devices storing data instructions that, when executed by the one or more processors, cause the system to:
present a wire product conversion user interface, the wire product conversion user interface including a conversion type control and a product characteristics control;
receive, via the conversion type control of the wire product conversion user interface, a conversion type input including at least a conductor material of a baseline wire product;
receive, via the product characteristics control of the wire product conversion user interface, a product characteristic input including one or more characteristics of the baseline wire product;
transmit, to a wire product conversion server, the conversion type input and the product characteristic input, wherein the conversion type input and the product characteristic input are usable by the wire product conversion server to determine the baseline wire product;
receive, from the wire product conversion server, one or more converted wire products, wherein the one or more converted wire products are selected by the wire product conversion server based, at least in part, on an ampacity of the baseline wire product, the one or more converted wire products having a different conductor material than the baseline wire product; and
present, via the wire product conversion user interface, the one or more converted wire products.

19. The system of claim 18, wherein the wire product conversion user interface further includes an installation conditions input.

20. The system of claim 19, wherein the system is further configured to:
receive, via the installation conditions input of the wire product conversion user interface, an installation conditions input including an installation condition of a wire product;
transmit, to the wire product conversion server, the installation conditions input, wherein the installation conditions input is usable by the wire product conversion server to determine, for each converted wire product of the one or more converted wire products, whether the converted wire product is compatible with the installation condition;
receive, from the wire product conversion server, a warning indicating that the converted wire product is not compatible with the installation condition; and
present, via the wire product conversion user interface, the warning.
